(19) United States
(12) Patent Application Publication
(10) Pub. No.: US 2007/0076521 A1
(43) Pub. Date: Apr. 5, 2007

(54) Agitator with integrated dual independent flow control

(76) Inventor: Ian K. Glasgow, Averill Park, NY (US)

Correspondence Address: IAN K. GLASGOW, 24 PROSPECT AVENUE, AVERILL PARK, NY, 12018, US

(21) Appl. No.: 11/203,541

(22) Filed: Aug. 15, 2005

(51) Int. Cl. B01F 11/00; F04B 43/08; F04B 43/12; F04B 45/06

(52) U.S. Cl. 366/209; 417/474

(57) ABSTRACT

The aim of the present invention is to provide a method of liquid flow control to an agitating instrument for mixing in a reaction vessel two or more substances of which at least one is a liquid phase. The vessel preferably comprises a container having an open upper end which may be advantageously surrounded by a rim, and a closed bottom end. The mixing device most preferably comprises a support plate upon which the vessel is placed. The flow control system dispenses and withdraws liquids from the reaction vessel. A control system can be integrated to dispense and withdraw liquids on a predetermined schedule, thereby automating otherwise tedious procedures.

### CROSS-REFERENCE TO RELATED APPLICATIONS

This application is based upon provisional application Ser. No. 60/600,333 with filing date Aug. 10, 2004.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The mixing and liquid flow control device and method presented herein generally relates to a laboratory instrument and specifically a rocker or shaker which operates at low speed for precise blending or stirring with an integrated fluid delivery system for dispensing and withdrawing fluids from the trays on the rocking platform.

2. Description of the Prior Art and Objectives of the Invention

In the mixing of most conventional liquid solutions blades or stirrers can be introduced directly therein for agitation. Other solutions and materials as are concerned with here require a high degree of care in handling and in these cases conventionally a beaker or other container which is to be stirred is rotated, shaken or otherwise agitated for the mixing process. In certain laboratory procedures the degree and amount of mixing may be critical and the laboratory technician must make sure that the blending is precisely repeatable. Lab technicians frequently have to agitate, stir or blend solutions which are very delicate, such as during protein, DNA and RNA staining operations where vigorous agitation may ruin the samples. Several devices have been promoted which gently agitate solutions in laboratory environments, such as U.S. Pat. Nos. 4,702,610; 4,893,938; and 5,593,228. Such devices are desirable in general to perform agitation in a smooth fashion without the introduction of bubbles or froth. Also, the laboratory technician typically needs to dispense and withdraw particular liquids from the reaction vessel multiple times. Devices for dispensing liquids for biological assays include U.S. Pat. Nos. 4,933,147; 5,630,986; and 6,300,142, but different assays have different liquid handling requirements and these inventions have limited applicability. For example in certain protein staining processes, a thin sheet of protein containing gelatin is placed within a beaker with a staining solution. The solution is then agitated causing the protein components within the gelatin to absorb the stain. Next the solution is poured out and a wash buffer is placed in the vessel, agitation occurs for a desired duration, and the wash buffer is then poured out. The wash buffer cycle is typically repeated two more times. This is a tedious process that ties up a technician for one to several hours and is often not precisely repeated due to the awkward time intervals. Other uses for an instrument that combines a pump for fluid delivery and a platform that translates or pivots to gently blend liquids include blot processing for DNA, RNA, and protein assays and liquid exchange and blending for immunofluorescence assays.

With these disadvantages known to conventional mixing devices and techniques the present invention was developed and one of its objectives is to provide a method and a device for automating the transport of liquids into and out of a reaction vessel in conjunction with the agitation.

Yet another objective of the present invention is to provide a mixing device which includes a speed control whereby the mixing speed can be precisely adjusted.

Still another objective of the present invention is to provide a mixing device which includes a pump which can be manually activated to dispense or withdraw liquid to the reaction vessel.

Other advantages and objectives of the present invention will become apparent to those skilled in the art as a more detailed description of the invention is revealed below.

### BRIEF SUMMARY OF THE INVENTION

The aim of the present invention is to provide a method of liquid flow control to an agitating instrument for mixing in one or more reaction vessels two or more substances of which at least one is a liquid phase. The vessel preferably comprises a container having an open upper end which may be advantageously surrounded by a rim, and a closed bottom end. The mixing device most preferably comprises a support plate upon which the vessel is placed. The flow control system dispenses and withdraws liquids from the reaction vessel. A control system can be integrated to dispense and withdraw liquids on a predetermined schedule, thereby automating otherwise tedious procedures.

The aforesaid and other objectives of the invention are realized by a pump, such as a peristaltic pump, which dispenses and withdraws liquids from the reaction vessel. Tubing runs from a source container, by the pump, and to a discharge fitting above the reaction vessel location. A second tubing runs from a fitting located in the reaction vessel, by the pump, to a waste container. By incorporating a “T” and a pair of oppositely oriented check valves in the source container, the pump can run in the first direction to dispense liquid from the source container to the reaction vessel, and when the pump runs in the second direction, air enters the tubing near the reaction vessel, but exits in the source container above the liquid level, thereby avoiding the production of bubbles. Likewise, a pair of check valves attached to the second tubing, near the reaction vessel, ensure that the pump withdraws waste liquid when it runs in the second direction, but when the pump runs in the first direction, air from the waste container is released from the second tubing system before reaching the reaction vessel.

In another embodiment, roller clutches connect the motor shaft to the rotors of the peristaltic pump, such that when the motor shaft rotates in the first direction, only the first rotor turns, thereby pumping only the first fluid. Friction and deformation resistance of the second tubing set prevent the second rotor from turning. When the motor shaft turns in the opposite direction, only the second rotor turns, thereby pumping only the second fluid, making the flow of fluid in the first tubing independent of the flow of fluid in the second tubing. By using multiple tubing in parallel, multiple fluids can be pumped simultaneously.

A platform, hinged in the middle, supports the reaction vessel. The motor is linked to the platform to cause the agitation of the platform. When the motor turns, a pin rotates about the axis of the motor shaft, thereby moving a linkage connected to the pin at the proximal end, and to the platform at the distal end, which in turn, causes the platform to tilt back and forth at the same frequency as the rate of rotation of the motor shaft.

A microprocessor based electronic circuit controls the motor timing and speed, thereby controlling the agitation of the platform, and controls the pump timing and direction, which controls the flow of liquid in and out of the reaction vessel(s). The technician can initiate agitation, dispensing, withdrawing of liquid, or all three according to a programmable schedule.

In another embodiment, the motor causes the platform to shake laterally in one or two directions, to shake in conjunction with the one axis tilting described above as rocking, to tilt in two axes, or some combination of these agitation methods.

In another embodiment, the method or device does not incorporate agitation of the platform. The reaction vessel could be on a stationary platform or on a platform controlled by a separate instrument.

In another embodiment, a separate instrument which agitates a platform upon which one or more reaction vessels can rest, is plugged into the instrument described above, and the power to the outlet is controlled by a relay, which in turn, is controlled by the microprocessor based electronics circuit, thereby effectively enabling the instrument described in this invention to control the agitation of the platform.

In another embodiment, there are pinch valves or valves of another type between the pump and the fluid containers so that fluidic connection between each of the containers and the pump can be selectively opened or closed. By closing off fluidic connection with all but one of the source containers, the fluid to be pumped to the container on the platform can be selected. By closing off fluidic connection with all but one of the waste containers, the fluid from the tray on the platform can be directed to a particular container. This enables a reagent to be returned to one container and wash buffer to a different container and multiple reagents to be used in sequence, with just a single pump.

### BRIEF DESCRIPTION OF THE DRAWINGS

The present invention, together with the above and other objects and advantages, can best be understood from the following detailed description of the embodiment of the invention illustrated in the accompanying assembly drawings and photographs.

FIG. 1a is a view of a rotor.

FIG. 1b is an exploded view of the same rotor showing the roller clutches and the rollers which attach to the rotor.

FIGS. 2a and 2b show the various components in the dual pump head.

FIG. 3 shows a block with an eccentric threaded hole which is attached to the motor shaft. As the motor turns, the block rotates about the motor shaft, and the shoulder screw in the block moves in a circular path. The shoulder screw forces a linkage to move. The other end of the linkage is attached to a pivot block mounted to the tilt platform. As the motor turns, the linkage moves, and the tilt platform rocks back and forth.

FIG. 4 shows a platform with several blocks attached to the underside. Each of the blocks has a press fit pin which serves as an axle about which either the tilt platform pivots or the linkage pivots.

FIG. 5 shows a fluid delivery device.

FIG. 6 shows the above described assemblies and some additional parts, such as a hinge which when “open” holds tubes either above the position for a tray on the tilt platform, and when “closed”, holds the tubes away from the tray position, so that the tray can be removed without interference from these tubes. Two other parts are the press bearings which are mounted into the chassis and support plate or support bar. These bearings enable the tilt platform to rock with minimal friction. The pins in two of the pivot blocks of the tilt platform assembly fit into these bearings.

### DETAILED DESCRIPTION OF THE PREFERRED EMBODIMENT

Assy Figure of Instrument Showing Movable Platform Tubing, Pump, Control Panel, Tray

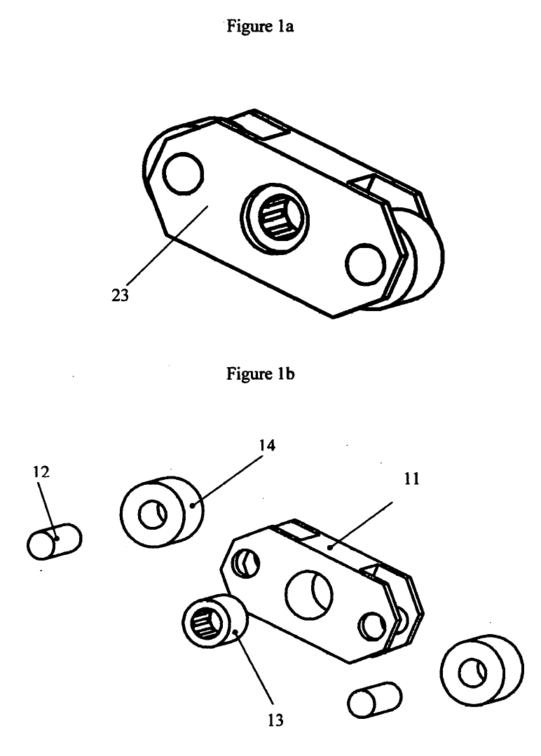

FIG. 1a shows a rotor (23) used in the peristaltic pump. FIG. 1b is an exploded assembly view of the same rotor (23). Rollers (11) slip over pins (12). The pins (12) are pressed into the body of the rotor (11). A one-way roller clutch (13) allows the rotor (23) to spin freely about a drive shaft in one direction.

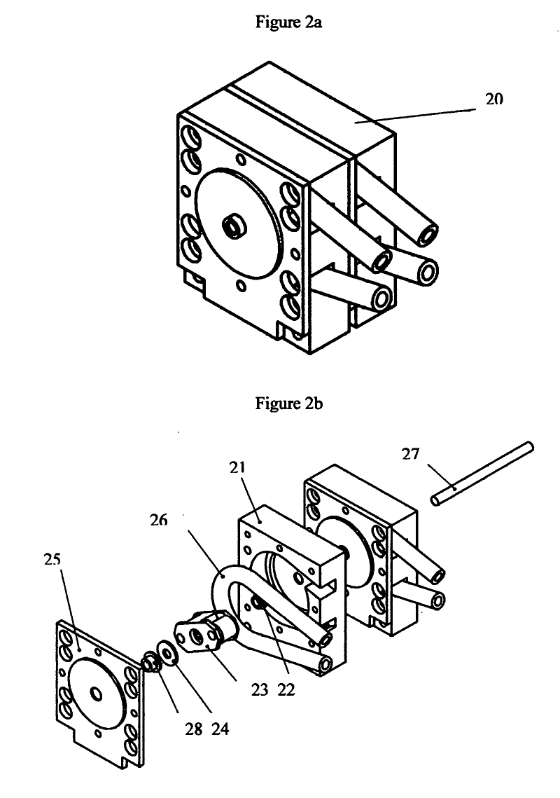

FIG. 2a shows the pump head (20). FIG. 2b is an exploded view of the pump head (20). When drive shaft (27) rotates clockwise, it causes one rotor (23) to turn. The other rotor does not turn. When the drive shaft (27) turns counterclockwise, the other rotor turns but the first one does not. Tubing (26) is squeezed between the rotor (23) and the housing (21). Washer (24) and bushing (28) provide low friction surfaces and cover (25) retains the parts from exiting the pump head.

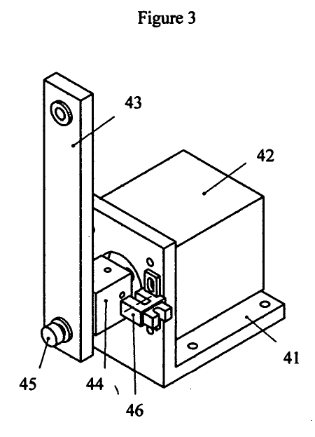

FIG. 3 shows the components driving the pivoting of the platform (2). Bracket (41) holds motor (42) and an optical sensor (46). As the motor shaft turns, eccentric block (44) causes the linkage (43) to move, pivoting about a shoulder screw (45) which is parallel to the motor shaft.

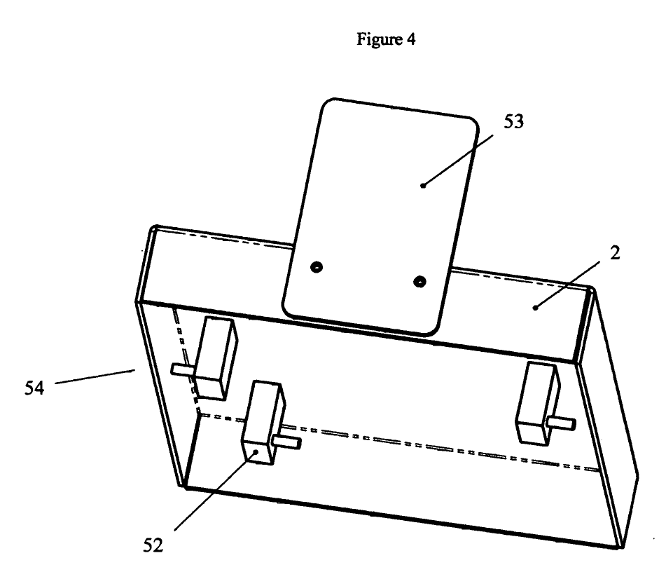

In FIG. 4, the platform (2) upon which one or more reaction vessels rest. Connection block (52) provides a pivot about which a linkage (43) can drive the platform (2) to pivot. Hinge plate (53) is a plate to which a fluid delivery device (61) can be hinged. The two pivot blocks (54) provide a pivot axis about which the platform (2) pivots.

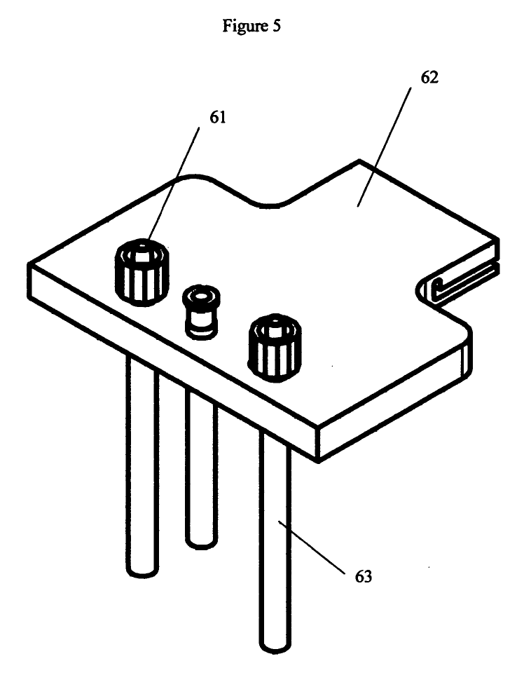

In FIG. 5, a dual delivery device (62) is shown. The three connectors (61) provide a means to connect tubing to the fluid delivery tubes (63).

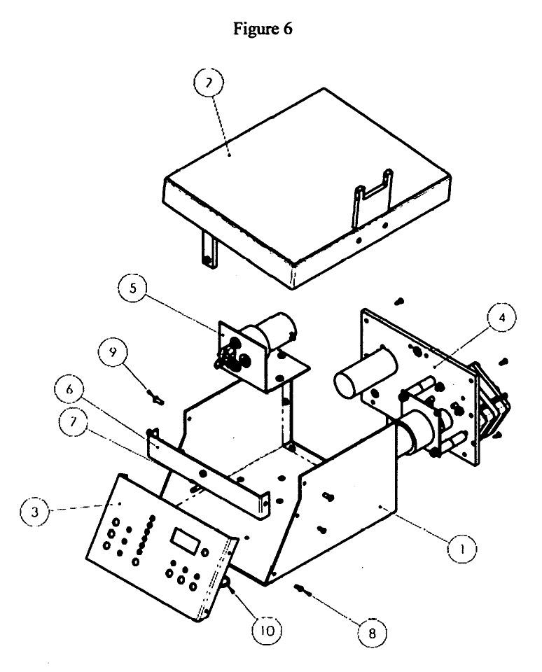

FIG. 6 is a top level assembly view, showing the platform (2), the chassis (1), the rear panel assembly (4) which contains the pump, screws (8, 9) for assembly, the rocking assembly (5), the front control panel (3), wires (10), and a front bracket (6) for supporting the pivot bearing (7). The other pivot bearing is in the rear panel assembly (4).

While the invention has been described with reference to the preferred embodiment thereof, it will be appreciated by those of ordinary skill in the art that various modifications can be made to the structure and function of the invention without departing from the spirit and the scope of the invention as a whole.

I claim:

1. A fluid transfer apparatus comprising:
a pump;
a container which is in fluid communication with the pump, from which tubing runs to the pump;
a second container tubing which is in fluid communication with the pump, from which a second tubing runs to the pump;
a set of tubings which run from the pump to the reaction vessel location;
a movable platform
a means for controlling the pump, wherein the pump can dispense liquid to a reaction vessel or set of reaction vessels, or withdraw liquid from the reaction vessel or set of reaction vessels, and
a means for controlling the movable platform wherein the platform can translate, pivot, or both.

2. The apparatus of claim 1 including a user interface wherein a user can adjust the timing and operation of the pump and the movable platform.

3. The apparatus of claim 2 wherein the pump is a peristaltic pump.

4. The apparatus of claim 3 wherein the peristaltic pump dispenses one set of fluids when powered to operate in a first direction, and a second, not mutually exclusive set of fluids when powered to operate in a second direction.

5. The apparatus of claim 4 including valves that are used to control which fluids are pumped in each direction of pumping.

6. The apparatus of claim 4 including clutches that are used to control which fluids are pumped in each direction of pumping.

7. The apparatus of claim 4 wherein the tubing is branched such that a single fluid is simultaneously pumped to or from multiple reaction vessels.

8. The apparatus of claim 4 wherein there are valves so that a single pump can selectively transfer fluids from a set of multiple source containers and also selectively transfer fluids to a set of multiple collection containers.

9. A peristaltic pump comprising,
a means of selective pumping one set fluids when powering to operate in a first direction and a different, but not mutually exclusive set of fluids when powered to operate in a second direction.

10. The apparatus of claim 9 including valves that are used to control which fluids are pumped in each direction of pumping.

11. The apparatus of claim 9 including clutches that are used to control which fluids are pumped in each direction of pumping.

12. The apparatus of claim 9 including valves so that a single pump can selectively transfer fluids from a set of multiple sources containers and selectively transfer fluids to a set of multiple collection containers.
